(19) United States
(12) Patent Application Publication
(10) Pub. No.: US 2021/0371965 A1
(43) Pub. Date: Dec. 2, 2021

(54) Thermal Spray Metal Coating for Coiled Sucker Rods

(71) Applicant: Pro-Rod, Inc., Edmonton (CA)

(72) Inventors: Alex Perri, Edmonton (CA); Denis Blaquiere, Edmonton (CA)

(21) Appl. No.: 17/333,947

(22) Filed: May 28, 2021

Related U.S. Application Data
(60) Provisional application No. 63/032,251, filed on May 29, 2020.

(51) Int. Cl. C23C 4/14; C23C 4/02; C23C 4/06; C23C 4/18; B05D 1/30; B05D 7/14; B05C 5/00

(52) U.S. Cl. CPC C23C 4/14; C23C 4/02; C23C 4/06; B05C 5/005; B05D 1/305; B05D 7/14; C23C 4/18

(57) ABSTRACT

The present disclosure relates to a method for coating a coiled sucker rod, the method comprising: (a) transferring the coiled sucker rod from a first reel to a thermal spray metal gun system with a conveyance system; and (b) applying a thermal spray metal coating on the coiled sucker rod with a thermal spray metal gun system to form a thermal spray metal coated coiled sucker rod.

### CROSS-REFERENCE TO RELATED APPLICATION

This application claims priority to U.S. Provisional Application No. 63/032,251, filed May 29, 2020, the contents of which is hereby incorporated in its entirety by reference.

### FIELD OF THE DISCLOSURE

The present disclosure relates, according to some embodiments, to coating systems and methods of applying a thermal spray metal to coat coiled sucker rods, and determining the state of coating processes.

### BACKGROUND

Sucker rods are used to operate downhole pumps as a part of an artificial lift system. Suckers rods can be used in a linear reciprocating motion in sucker rod pumping systems or in a rotary motion as seen in a progressing cavity pumping systems. As the sucker rods either rotate or reciprocate through the wells deviated tubing string, the string is subject to wear and corrosion. Further, corrosion can happen anywhere in the well. Uneven wear and corrosion of the components leads to costly maintenance and repairs. To counteract this, a coating is applied to the outside surface of the sucker rod.

Two previously existing coating techniques used with coiled sucker rods are polymer coating and fusion bonded epoxy (FBE) coating. The polymer coating technique does not bond well with the sucker rod surface and is prone to disbondment. This leads to a limitation of the depth of well in which this coated coiled sucker rod string can be installed. The deeper the well, the more squeeze pressure the injector units, which deploy and retrieve coiled sucker rod strings from wells, need to hold onto the sucker rod strings. Since the polymer coating does not bond well enough, the squeeze pressure strips or sloughs off the polymer coating from the sucker rod surface. This is especially true when trying to retrieve the coated sucker rod string from the well after it has been down hole for any period of time. Additionally, polymer coating that has fallen off can plug flow lines. Further, the coating can peel off as the coiled sucker rod is removed from the well, therefore leaving the coiled sucker rod unprotected for further use. If the coating peels while in the well bore, the loose coating can plug the pump and/or the flow lines, leading to unwanted and expensive repairs.

Fusion bonded epoxy coatings provide a modest protection against corrosion caused by contact with down well chemicals, but such coatings are also subject to abrasion. Additionally, application of fusion bonded epoxy coating systems involves complicated, timely, and costly procedures. As these coatings are worn, repairs to such systems are problematic and expensive to repair.

In contrast to the above coatings, thermal spray metal (TSM) coatings bond very well to sucker rod surfaces. Since a metal may be a relatively soft metal, as a TSM coating wears, the TSM coating smears off instead of spalling off in larger pieces or splinters as do FBE and polymer coatings. Therefore, TSM coatings will not plug up flow lines or contaminant production fluids. TSM coatings are also relatively inexpensive, and do not as readily spall off of the sucker rod surfaces while being serviced compared to either fusion bonded epoxy or polymer coatings.

Additionally, TSM coatings provide a high level of corrosion resistance. Upon contact with corrosive chemicals, the metal coating (e.g., aluminum, zinc, and magnesium) forms a thin but effective oxide layer that prevents further oxidation. Metals including aluminum, zinc, and magnesium form a thin layer of oxide after exposure to a corrosive environment. These metals are substantially impermeable and adhere strongly to the parent metal or substrate of the sucker rod surface. Metal coatings may also act as a sacrificial anode, protecting areas where the coating may have been worn off, therefore protecting the entire rod string. However, while metal coatings have been thus far applied to sections of a sucker rod string, a need has yet been met for systems and methods for coating a coiled sucker rod.

### SUMMARY

The present disclosure relates, according to some embodiments, to a method for coating a coiled sucker rod, the method including (a) transferring the coiled sucker rod from a first reel to a thermal spray metal gun chamber with a conveyance system; and (b) applying a thermal spray metal coating on the coiled sucker rod with a thermal spray metal gun chamber to form a thermal spray metal coated coiled sucker rod. The thermal spray metal coating may include an aluminum, a zinc, a manganese, and alloys thereof. The thermal spray metal coating may be applied at a thickness ranging from about 0.1 millimeters to about 5.0 millimeter.

A method for coating a coiled sucker rod may include transferring a coiled sucker rod from a first reel to a pre-heater with a conveyance system. The conveyance system may include a pinch roller and a wheel drive. The method may include pre-heating of the coiled sucker rod with the pre-heater to a temperature ranging from about 0° C. to about 300° C. to form a pre-heated coiled sucker rod. The method may include transferring of the coiled sucker rod from the first reel to an abrasive media blasting device with the conveyance system and blasting the pre-heated coiled sucker rod with an abrasive media from the abrasive media blasting device to form a pre-treated coiled sucker rod. The abrasive media may include a grit, a shot, an alumina, a silica, and a combination thereof. The method may include transferring the coiled sucker rod from the first reel to a pre-heater with the conveyance system and pre-heating the coiled sucker rod with the pre-heater to a temperature ranging from about 0° C. to about 300° C. to form a pre-heated coiled sucker rod.

A method disclosed herein may include transferring a pre-heated coiled sucker rod from a pre-heater to an abrasive media blasting device with a conveyance system and blasting the pre-heated coiled sucker rod with an abrasive media in the abrasive media blasting device to form a pre-treated coiled sucker rod. The method may include transferring the pre-treated coiled sucker rod from the abrasive media blasting device to the thermal spray metal gun chamber with the conveyance system. The method may include drawing a thermal spray metal coated coiled sucker rod into a second reel with the conveyance system. The method for coating the coiled sucker rod may include transferring the thermal spray metal coated coiled sucker rod from a thermal spray metal gun chamber to a sealant applicator system with the conveyance system and applying a sealant to the thermal spray metal coated coiled sucker rod in the sealant applicator system to produce a sealed coiled sucker rod. The sealant may include one or more of an epoxy, a silicone, a phenol resin, a moisture cured urethane, a urethane, an aliphatic urethane. The sealant may be applied at a thickness ranging from about 0.1 millimeters to about 5.0 millimeter. In some embodiments, the sealant applicator system may include a waterfall sealant booth.

A method for coating a coiled sucker rod may include transferring of a sealed coiled sucker rod from a sealant applicator system to a post-heater with a conveyance system and curing a sealant on the sealed coiled sucker rod in a post-heater to form a cured sealant-coiled sucker rod. The post-heater may be set at a temperature ranging from about 50° C. to about 150° C. The method may include drawing the cured sealant-coiled sucker rod from the post-heater into a second reel with the conveyance system.

According to some embodiments, a system for coating a coiled sucker rod may include a conveyance system configured to transport the coiled sucker rod to different components of the system and a first reel configured to contain a coiled sucker rod. A system may include a pre-heater connected to the first reel through the conveyance system and configured to receive the coiled sucker rod from the first reel through actuation of the conveyance system. The pre-heater may be configured to heat the coiled sucker rod to a temperature ranging from about 0° C. to about 300° C., forming a pre-heated coiled sucker rod. A system may include an abrasive media blasting device including an abrasive media tank, a compressor, and an air tank. The abrasive media blasting device may be connected to the pre-heater through the conveyance system and may be configured to receive the pre-heated coiled sucker rod from the pre-heater through actuation of the conveyance system. The abrasive media blasting device may be configured to blast the pre-heated coiled sucker rod with the abrasive media to form a pre-treated coiled sucker rod.

A system may include a thermal spray metal gun chamber connected to an abrasive media blasting device through a conveyance system. A thermal spray metal gun chamber may be configured to receive a pre-treated coiled sucker rod from the abrasive media blasting device through actuation of the conveyance system, wherein the thermal spray metal gun chamber is further configured to apply a thermal spray metal coating on the pre-treated coiled sucker rod to form a thermal spray metal coated coiled sucker rod. The system may include a computer processor electronically connected to and configured to control the conveyance system, a pre-heater, the abrasive media blasting device, the thermal spray metal gun chamber, a degreasing system, a sealant applicator system, and a post-heater. A degreasing system may be located in between the pre-heater and the abrasive media blasting device. The degreasing system may be connected to each of the pre-heater and the abrasive media blasting device through the conveyance system. The degreasing system may include one or more of a heater configured to heat the pre-heated coiled sucker rod to a temperature ranging from about 0° C. to about 300° C., a high pressure water spray system comprising a water tank, a pump, and one or more spray nozzles, a degreasing applicator system comprising a solvent drum, a pump, and one or more spray nozzles, and an air dryer.

A system for coating the coiled sucker rod may include a sealant applicator system that may be connected to a thermal spray metal gun chamber through a conveyance system. The sealant applicator system may be configured to receive a thermal spray metal coated coiled sucker rod from the thermal spray metal gun chamber through actuation of the conveyance system. The sealant applicator system may be configured to apply a sealant to the thermal spray metal coated coiled sucker rod to produce a sealed coiled sucker rod. In some embodiments, the sealant applicator system may include a waterfall sealant booth. The system may include a post-heater containing one or more heaters and may be connected to the sealant applicator system through the conveyance system. The post-heater may be configured to receive the sealed coiled sucker rod from the sealant applicator system through actuation of the conveyance system. The post-heater may be configured to heat the sealed coiled sucker rod to a temperature ranging from about 50° C. to about 150° C. to form a cured sealant-coiled sucker rod. The system may include a second reel configured to receive the cured sealant-coiled sucker rod from the post-heater through actuation of the conveyance system. The conveyance system may include a pinch roller, a reel drive, offset roller system, and a belt puller.

### BRIEF DESCRIPTION OF THE DRAWINGS

Some embodiments of the disclosure may be understood by referring, in art, to the present disclosure and the accompanying drawings, wherein:

FIG. 1 illustrates an application of a thermal spray metal coating onto a sucker rod surface including a surface preparation and a thermal metal spray step, according to a specific example embodiment of the disclosure;

FIG. 2A illustrates a top view of a system for applying a thermal spray metal coating, according to a specific example embodiment of the disclosure; and

FIG. 2B illustrates a side view of the system from FIG. 2A for applying a thermal spray metal coating, according to a specific example embodiment of the disclosure.

### DETAILED DESCRIPTION

Disclosed in the present application are methods and systems for coating coiled sucker rods with a thermal spray metal coating. In contrast with known methods that singly coat individual sections of a sucker rod string, the present system components function synergistically to continuously coat a coiled sucker rod from end-to-end.

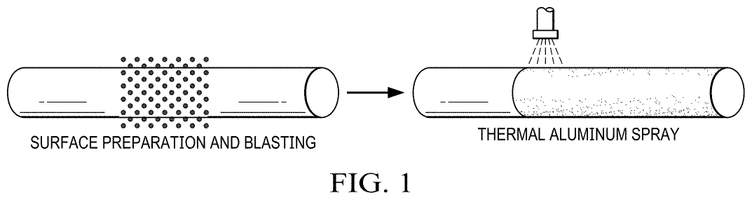

FIG. 1 shows a view of an application of a thermal spray metal (TSM) onto a section of a sucker rod surface. As shown in FIG. 1, disclosed methods of applying a TSM coating onto a sucker rod surface include a first step of surface preparation and a second step of TSM application. The surface preparation may include a grit blast to remove an outside contaminant layer such as mill scale off of the surface to provide for a known surface profile. Abrasive blasting materials include aluminum oxide (alumina), silicon dioxide (silica), grit (e.g., steel grit), shot (e.g., steel shot), walnut shells, and glass beads. Once the surface has been prepared, the thermal metal spray step may be performed. The thermal metal spray step may involve a process where melted or heated metal (e.g., aluminum, zinc, magnesium, and alloys thereof) is sprayed onto the sucker rod surface. A metal feedstock, which can either be metal wire or metal powder, may be heated by electrical methods (e.g., plasma and arc), by flame heating, or by other known techniques. The metal coating may be applied as thin as 0.1 millimeters and as thick as 5 millimeters, or it may be applied to other thicknesses according to design needs. The metal feedstock may include high purity metal wire grade, which is greater than 99% pure or may include minor impurities.

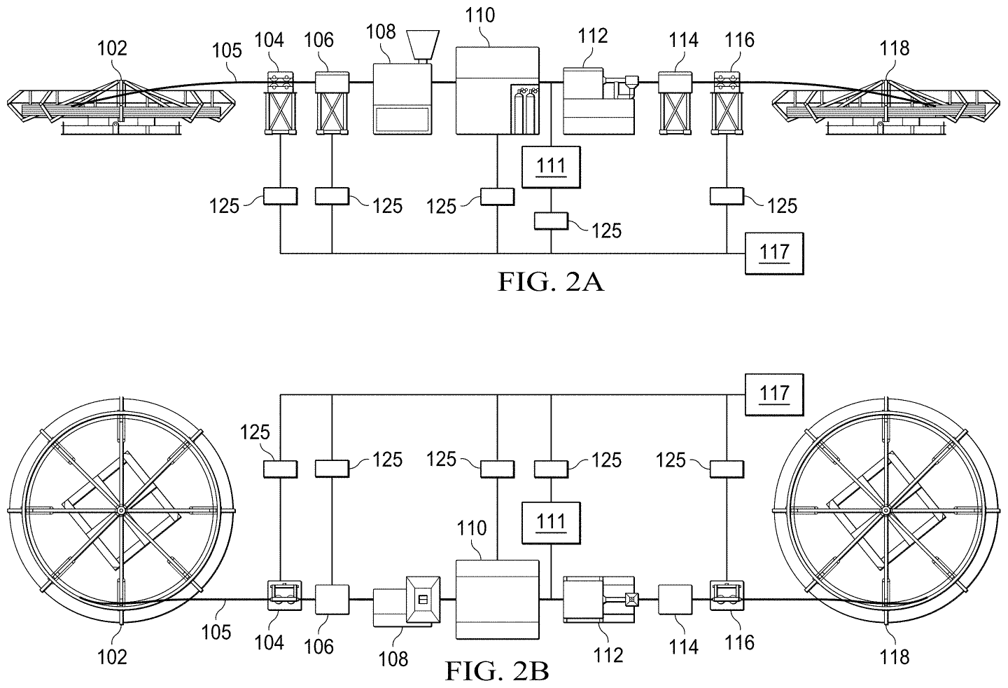

While FIG. 1 shows how a TSM is applied to a section of a sucker rod surface, FIGS. 2A and 2B show a disclosed system 100 for applying a TSM onto an entire coiled sucker rod. FIG. 2A illustrates a top view of the system 100 for applying a TSM coating and FIG. 2B illustrates a side view of the system 100 from FIG. 2A.

### Systems for Applying a Thermal Spray Metal to Coat a Coiled Sucker Rod

As shown in FIGS. 2A and 2B, a system 100 for applying a TSM to coat a coiled sucker rod 105 includes a first reel 102, a first conveyance system 104, a pre-heater 106, an abrasive media blasting device 108, a TSM gun system 110, a TSM inspector 111, a sealant applicator system 112, a post-heater 114, a second conveyance system 116, a computer processor 117, and a second reel 118. Each of the components of a disclosed system 100 can be assembled in various configurations and are connected to each other through at least one of the first conveyance system 104 and the second conveyance system 116. Each of the components of the disclosed system 100 may be electrically connected to each other through the computer processor 117 that may be configured to control each of the system 100 components. The system 100 components may function synergistically to continuously prepare a TSM-coated coiled sucker rod that is ready to be used downhole.

As shown in FIGS. 2A and 2B, first reel 102 may include a spool that is configured to hold an uncoated coiled sucker rod. The first reel 102 may hold from about 100 meters of coiled rod to about 5,000 meters of coiled sucker rod 105, or more. For example, the first reel 102 may hold about 100 meters of coiled rod, or about 500 meters, or about 1,000 meters, or about 1,500 meters, or about 2,000 meters, or about 2,500 meters, or about 3,000 meters, or about 3,500 meters, or about 4,000 meters, or about 4,500 meters, or about 5,000 meters, where about includes plus or minus 250 meters. To accommodate various coiled sucker rod 105 lengths, the first reel 102 may have a diameter ranging from about 5 feet to about 30 feet. For example, the first reel 102 may have a diameter of about 5 feet, or about 10 feet, or about 15 feet, or about 20 feet, or about 25 feet, or about 30 feet, or about 35 feet, or about 40 feet, or about 40 feet, where about includes plus or minus 2.5 feet. Through one of a first or second conveyance systems 104, 116, the first reel 102 may be operatively connected to any one of a pre-heater 106, an abrasive media blasting device 108, a thermal spray metal gun system 110, a thermal spray metal inspector 111, a sealant applicator system 112, a post-heater 114, and a second reel 118. In some embodiments, through actuation of the first or second conveyance systems 104, 116, the first reel 102 may be configured to transfer the coiled sucker rod 105 to any one a pre-heater 106, the abrasive media blasting device 108, the TSM gun system 110, the TSM inspector 111, the sealant applicator system 112, the post-heater 114, and the second reel 118. The first reel 102 advantageously provides the system 100 with a bare coiled sucker rod holder and provider that is configured to feed the bare coiled sucker rod to other components of the system 100 so that a TSM-coated sucker rod may be continuously produced.

As is shown in FIGS. 2A and 2B, a first conveyance system 104 may be located in between a first reel 102 and a pre-heater while a second conveyance system 116 may be placed in between a post-heater 114 and a second reel 118. However, any number of conveyance systems 104, 116 may be incorporated and they may be placed in between any of the system 100 components shown. The conveyance system 104, 116 may include one or more of a pinch roller, a reel drive, offset roller system, and a belt puller. The conveyance system 104, 116 may be electrically connected to a computer processor 117 that may be operable to control the speed in which the conveyance system 104, 116 transfers the coiled sucker rod 105 from the first reel 102 to any other components within the system 100. Disclosed conveyance systems 104, 116 synergistically operate with other system 100 components to move the coiled sucker rod 105 from one component to the other in any speed and direction required so that production of a TSM-coated coiled sucker rod is continuous and able to form a uniform final product. For example, each of the conveyance systems 104, 116 may slow down the speed that the coiled sucker rod 105 is being transferred to a TSM gun system 110 if the TSM coating is found to be too thin by the TSM inspector 111. Conversely, the conveyance systems 104, 116 may increase the speed that the coiled sucker rod 105 is being transferred to the TSM gun system 110 if the TSM coating is found to be too thick by the TSM inspector 111.

System 100 may include a pre-heater 106 located in between a first reel 102 and an abrasive media blasting device 108. The pre-heater 106 may include a housing configured to contain one or more heating elements configured to transfer heat to a coiled sucker rod 105 to form a pre-heated coiled sucker rod. The pre-heater 106 may be configured to receive the coiled sucker rod 105 from the first reel 102 through actuation of the conveyance system 104, 116. The coiled sucker rod 105 may pass through all or part of the housing as it is received by the pre-heater 106. The pre-heater 106 is configured to heat the coiled sucker rod 105 to a temperature ranging from about 0° C. to about 300° C. to form a pre-heated coiled sucker rod. For example, the pre-heater 106 may heat the coiled sucker rod 105 to a temperature of about 0° C., or about 25° C., or about 50° C., or about 75° C., or about 100° C., or about 125° C., or about 150° C., or about 175° C., or about 200° C., or about 225° C., or about 250° C., or about 275° C., or about 300° C., where about includes plus or minus 12.5° C. Pre-heating a coiled sucker rod may remove oils, organic compounds, and moisture from the coiled sucker rod 105, thereby forming the pre-heated coiled sucker rod. The pre-heater 106 advantageously provides for a uniform and clean pre-heated coiled sucker rod that aids in production of a uniform final TSM-coated sucker rod.

System 100 may include an abrasive media blasting device 108 located in between a thermal spray metal gun system 110 and one or more of a first reel 102 and a pre-heater 106. The abrasive media blasting device 108 may be configured to receive a coiled sucker rod 105 from the first reel 102 and/or the pre-heater 106 through actuation of the conveyance system 104, 116. After being preheated at pre-heater 106, an uncoated coiled sucker rod may be transferred to the abrasive media blasting device 108 for surface preparation and blasting to produce a pre-treated coiled sucker rod. The abrasive media blasting device 108 may include a housing configured to contain and/or support an abrasive media tank, an abrasive media spray nozzle, a compressor, and an air tank. The abrasive media blasting device 108 may also include a wheel style blasting system including a roller conveyor shot blaster, an abrasive gate, a turbine, a bucket elevator, a pre-separator, a filter, an abrasive media reclaimer, an abrasive media tank, an abrasive removal unit, a control panel, a light barrier, an air shock filter, a safety filter, and a dust bag. An abrasive media tank may be configured to contain any type of abrasive media including an aluminum oxide, a silicon dioxide, a grit (e.g., steel grit), a shot (e.g., steel shot), walnut shells, glass beads, a sand, and mixtures thereof. The abrasive media spray nozzle may connect to the abrasive media tank, the compressor, and the air tank through a series of air hoses and may be configured to discharge the abrasive media from a tip of the abrasive media spray nozzle at various speeds. An abrasive media may have any mesh size ranging from about 3.5 to about 200. An abrasive media may have a mesh size including about 3.5, or about 25, or about 50, or about 75, or about 100, or about 125, or about 150, or about 175, or about 200, where about includes plus or minus 12.5. For example, the abrasive media materials may include a 16 to 24 mesh metal oxide (e.g., aluminum oxide). A surface blasted by the abrasive media can have an angular profile from about 0.635 mm (2.5 mil) to about 0.1143 mm (4.5 mil). A blasted surface can have an angular profile of about 2.5 mil, or about 2.75 mil, or about 3.0 mil, or about 3.25 mil, or about 3.5 mil, or about 3.75 mil, or about 4.0 mil, or about 4.25 mil, or about 4.5 mil, where about includes plus or minus 0.125 mil. The abrasive media blasting device 108 advantageously provides for a clean and uniform pre-treated coiled sucker rod that functions with other system components to provide for a uniform TSM-coated coiled sucker rod in a continuous manner. Rates in which the coiled sucker rod 105 is fed through the abrasive media blasting device 108 may be increased or decreased by the conveyance systems 104, 116 based on inspection of the pre-treated coiled sucker rod or the TSM-coated coiled sucker rod.

System 100 may include a thermal spray metal gun system 110 located in between a thermal spray metal inspector 111 and a first reel 102, a pre-heater 106, or an abrasive media blasting device 108. The TSM gun system 110 may be configured to receive a coiled sucker rod 105 from the first reel 102, the pre-heater 106, or the abrasive media blasting device 108 through actuation of the conveyance system 104, 116. The TSM gun system 110 may apply a TSM coating on a bare and/or pre-treated coiled sucker rod to form a thermal spray metal coated coiled sucker rod. A TSM gun system 110 may include one or more spray metal guns connected to a spray metal container, a compressor, a heating unit, and an air tank through a series of air hoses. For example, disclosed TSM gun system 110 may include three spray metal guns placed in an orientation of about 120° apart or four thermal spray guns placed in an orientation of about orientation 90° apart. The thermal spray guns may be placed at any relative distance from each other and at any relative angle with respect to each other. A TSM gun system 110 may include a housing configured to support a spray metal gun. The housing may be any general shape or size and may be made of metal, plastic, or both. A spray metal container may be any size or shape and may be configured to contain a spray metal including an aluminum, a zinc, a magnesium, and alloys thereof. Rates in which the coiled sucker rod 105 is fed through the TSM gun system 110 may be increased or decreased by the conveyance systems 104, 116 based on inspection of the TSM-coated coiled sucker rod. For example, if the TSM-coated coiled sucker rod is found to have a TSM coating that is too thick, the conveyance systems 104, 116 may increase the rate in which the coiled sucker rod 105 is fed through the TSM gun system 110. In some embodiments, if the TSM-coated coiled sucker rod is found to have a TSM coating that is too thin, the conveyance systems 104, 116 may slow down the rate in which the coiled sucker rod 105 is fed through the TSM gun system 110.

A disclosed system 100 may include a TSM inspector 111 to measure a thickness of a TSM coating on a TSM-coated coiled sucker rod and also to detect any holes and/or voids in the coating. The TSM inspector 111 may be located in between a sealant applicator system 112 and the TSM gun system 110. The TSM inspector 111 may be configured to receive the TSM-coated coiled sucker rod from the TSM gun system 110 through actuation of the conveyance system 104, 116. The TSM inspector 111 includes a laser method, an eddy current method, and/or an ultrasonic method. In some embodiments, if the thickness of the TSM coating is not thick enough, the TSM-coated coiled sucker rod may be transferred back to the TSM gun system 110 for subsequent TSM treatments. Information produced by the TSM inspector 111 may be used by the computer processor 117 to make adjustments to any other components of system 100 as a quality control measure to ensure a uniform TSM-coated coiled sucker rod.

In some embodiments, a disclosed system 100 includes a sealant applicator system 112 configured to apply a sealant on the TSM-coated coiled sucker rod to produce a sealed coiled sucker rod. The sealant applicator system 112 may be configured to receive the TSM-coated coiled sucker rod from any one of the TSM gun system 110 and the TSM inspector 111 through actuation of the conveyance system 104, 116. In some embodiments, a sealant applicator system 112 may include a waterfall sealant booth. The waterfall sealant booth may include a wiper and a flowing waterfall of the sealant that the TSM-coated coiled sucker rod passes through to produce the sealed coiled sucker rod. In some embodiments, the sealant applicator system 112 may alternatively include a sealant drum, a pump, a compressor, an air tank, and a nozzle, where each component is connected through a series of air hoses and configured to project the sealant from the nozzle onto the TSM-coated coiled sucker rod. The sealant may include an epoxy, a silicone, a phenol resin, a moisture cured urethane, a urethane, an aliphatic urethane, and mixtures thereof. A sealant may be applied by the sealant applicator system 112 onto the TSM-coated coiled sucker rod at a thickness ranging from about 0.1 millimeters to about 5.0 millimeter. For example, a sealant may be applied at a thickness of about 0.1 millimeters, or about 0.2 millimeters, or about 0.3 millimeters, or about 0.4 millimeters, or about 0.5 millimeters, or about 0.6 millimeters, or about 0.7 millimeters, or about 0.8 millimeters, or about 0.9 millimeters, or about 1.0 millimeters, where about includes plus or minus 0.05 millimeters. The sealant may be applied at a thickness of about 1.0 millimeter, or about 2.0 millimeter, or about 3.0 millimeter, or about 4.0 millimeter, or about 5.0 millimeter, where about includes plus or minus 0.5 millimeter. Rates in which the TSM-coated coiled sucker rod is fed through the sealant applicator system 112 may be increased or decreased by the conveyance systems 104, 116 based on inspection of the sealed coiled sucker rod. For example, if the sealed coiled sucker rod is found to have a sealant that is too thick, the conveyance systems 104, 116 may speed up the rate in which the TSM-coated coiled sucker rod is fed through the sealant applicator system 112. In some embodiments, if the sealed coiled sucker rod is found to have a sealant that is too thin, the conveyance systems 104, 116 may slow down the rate in which the TSM-coated coiled sucker rod is fed through the sealant applicator system 112.

In some embodiments, a system 100 may include a post-heater 114 configured to receive and heat a sealed coiled sucker rod to form a cured sealant-coiled sucker rod. The post-heater 114 may be configured to receive the sealed coiled sucker rod from the sealant applicator system 112 through actuation of the conveyance system 104, 116. The post-heater 114 includes a housing configured to support one or more heaters and to receive and to surround at least a portion of the sealed coiled sucker rod. The post-heater 114 is configured to heat the sealed coiled sucker rod to a temperature ranging from about 50° C. to about 200° C. to form a cured sealant-coiled sucker rod. For example, the post-heater 114 may be configured to heat the sealed sucker rod to a temperature of about 50° C., or about 75° C., or about 100° C., or about 125° C., or about 150° C., or about 175° C., or about 200° C., where about includes plus or minus 12.5° C. The post-heater 114 may function synergistically with the other components of the system 100 so that a cured coiled sucker rods may be produced from a bare coiled sucker rod in a continuous manner by increasing the cure rate of the seal on the sealed coiled sucker rod.

As shown in FIGS. 2A and 2B, system 100 may include a second reel 118 configured to receive a coiled sucker rod 105, a TSM-coated sucker rod, a sealed coiled sucker rod, or a cured coiled sucker rod through actuation of the conveyance system 104, 116. For example, the second reel 118 may receive various forms of the coiled sucker rod 105 from any one of the first reel 102, the pre-heater 106, the abrasive media blasting device 108, the TSM gun system 110, the TSM inspector 111, the sealant applicator system 112, and the post-heater 114 through actuation of the conveyance system 104, 116. The second reel 118 may hold from about 100 meters of coiled rod to about 5,000 meters of coiled sucker rod 105, or more. For example, the second reel 118 may hold about 100 meters of coiled rod, or about 500 meters, or about 1,000 meters, or about 1,500 meters, or about 2,000 meters, or about 2,500 meters, or about 3,000 meters, or about 3,500 meters, or about 4,000 meters, or about 4,500 meters, or about 5,000 meters, where about includes plus or minus 250 meters. To accommodate various coiled sucker rod 105 lengths, the second reel 118 may have a diameter ranging from about 5 feet to about 30 feet. For example, the second reel 118 may have a diameter of about 5 feet, or about 10 feet, or about 15 feet, or about 20 feet, or about 25 feet, or about 30 feet, or about 35 feet, or about 40 feet, or about 40 feet, where about includes plus or minus 2.5 feet. The second reel 118 may function with other components of the system 100 to synergistically produce a TSM-coated coiled sucker rod by receiving and storing the TSM-coated coiled sucker rod as it is produced in a timely manner.

Disclosed systems include sensors 125 on the first reel 102, the conveyance system 104, the pre-heater 106, the abrasive media blasting device 108, the TSM gun system 110, the TSM inspector 111, the sealant applicator system 112, the post-heater 114, the second conveyance system 116, and the second reel 118. Each sensor may provide data to the computer processor 117 that may be stored by the computer processor 117 in a computer-readable medium. The computer processor 117 may control each system component instantaneously or through computer-readable instructions stored in the computer-readable medium. For example, the computer processor 117 may control the rate in which the uncoated coiled sucker rod is transferred from first reel 102 through first conveyance system 104 to pre-heater 106. Disclosed computer processors 117 may control the temperatures of pre-heater 106 and post-heater 114. In some embodiments, computer processor 117 may control TSM gun spray rate in the TSM gun system 110.

In certain usage environments, the processor 117 may detect, through the TSM inspector sensor 125, that there is insufficient coverage of TSM on the coiled sucker rod. In that instance, according to measurements from other sensors 125 and/or other measured environmental or manufacturing conditions, the processor 117 can decrease the speed of the conveyance systems 104, 116, increase the heat of the pre-heater 106, or increase the TSM gun spray rate in the TSM gun system 110. Conversely, if the measured TSM thickness is measured to be too thick according to measurements from sensors 125, the processor 117 can increase the speed of the conveyance systems 104, 116, decrease the heat of the pre-heater 106, or decrease the TSM gun spray rate in the TSM gun system 110.

### Methods for Applying a Thermal Spray Metal to Coat a Coiled Sucker Rod

The present disclosure relates, according to some embodiments, to methods for coating a coiled sucker rod 105 with a TSM coating to produce a TSM-coated coiled sucker rod. Disclosed methods include a step of transferring the coiled sucker rod 105 from a first reel 102 to a thermal spray metal gun system 110 with a conveyance system 104. The method may include applying the thermal spray metal coating on the coiled sucker rod 105 with the thermal spray metal gun system 110. The thermal spray metal coating may include an aluminum, a zinc, a magnesium, and alloys thereof. In some embodiments, the thermal spray metal coating may be applied at a thickness ranging from about 0.1 millimeters to about 5.0 millimeter. For example, a thermal spray metal coating may be applied at a thickness of about 0.1 millimeters, or about 0.5 millimeters, or about 1.0 millimeters, or about 1.5 millimeters, or about 2.0 millimeters, or about 2.5 millimeters, or about 3.0 millimeters, or about 3.5 millimeters, or about 4.0 millimeters, or about 4.5 millimeters, or about 5.0 millimeters, where about includes plus or minus 0.25 millimeters.

In some embodiments, a method may include transferring a coiled sucker rod from a first reel 102 to a pre-heater 106 with the conveyance system 104, 116 and pre-heating the coiled sucker rod with the pre-heater 106 to a temperature ranging from about 0° C. to about 300° C. to form a pre-heated coiled sucker rod. The pre-heating step may be performed before application of the TSM coating so that the pre-heated coiled sucker rod is clean before the TSM coating is applied to the coiled sucker rod 105. The method may include transferring a pre-heated coiled sucker rod from the pre-heater 106 to a thermal spray metal gun system 110 with the conveyance system 104, 116 so that a TSM may be applied to the pre-heated coiled sucker rod to form a TSM-coated coiled sucker rod.

A method described herein may include a step of transferring the coiled sucker rod 105 from the first reel 102 to an abrasive media blasting device 108 with the conveyance system 104, 116. A method may include a step of transferring a pre-heated coiled sucker rod from the pre-heater 106 to the abrasive media blasting device 108 with the conveyance system 104, 116. The disclosed methods may include blasting coiled sucker rod and/or the pre-heated coiled sucker rod with an abrasive media from the abrasive media blasting device 108 to form a pre-treated coiled sucker rod. The method may include transferring a pre-treated coiled sucker rod from the abrasive media blasting device 108 to a thermal spray metal gun system 110 with the conveyance system 104, 116 so that a TSM may be applied to the pre-treated coiled sucker rod to form a TSM-coated coiled sucker rod.

In some embodiments, a method may include transferring the TSM-coated coiled sucker rod from the thermal spray metal gun system 110 to a sealant applicator system 112 with the conveyance system 104, 116. The disclosed methods may include applying a sealant to the TSM-coated coiled sucker rod to produce a sealed coiled sucker rod. In some embodiments, the sealed coiled sucker rod may be transferred from the sealant applicator system 112 to the post-heater 114 with the conveyance system 104, 116 so that the sealed coiled sucker rod can be cured by a heat treatment. A method may include drawing the TSM-coated coiled sucker rod, the sealed coiled sucker rod, and/or the sealed coiled sucker rod into a second reel 118.

The corrosion and wear associated with downhole systems reduces the lifespan of coiled sucker rods. Disclosed systems for and methods of applying a TSM coating onto the coiled sucker rods increases the lifespan of and therefore reduces operating costs of using the sucker rods to produce oil from an oil well. The systems and methods disclosed herein may continuously or step-wise transform an uncoated coiled sucker rod into a TSM-coated and an epoxy sealed coiled sucker rod that may be resistant to both corrosion and wear.

As will be understood by those skilled in the art who have the benefit of the instant disclosure, other equivalent or alternative compositions, devices, methods, and systems for coating a coiled sucker rod can be envisioned without departing from the description contained herein. Accordingly, the manner of carrying out the disclosure as shown and described is to be construed as illustrative only.

Persons skilled in the art may make various changes in the nature, number, and/or arrangement of parts or steps without departing from the scope of the instant disclosure. For example, the size of a device and/or system may be scaled up or down to suit the needs and/or desires of a practitioner. Each disclosed method and method step may be performed in association with any other disclosed method or method step and in any order according to some embodiments. Where the verb “may” or “can” appears, it is intended to convey an optional and/or permissive condition, but its use is not intended to suggest any lack of operability unless otherwise indicated. Where open terms such as “having” or “comprising” are used, one of ordinary skill in the art having the benefit of the instant disclosure will appreciate that the disclosed features or steps optionally may be combined with additional features or steps. Where “based on” or “based upon” is used, one of ordinary skill in the art having the benefit of the instant disclosure will appreciate that it means one thing is dependent at least in part on another thing, directly or indirectly, exclusively or non-exclusively. Such option may not be exercised and, indeed, in some embodiments, disclosed systems, compositions, apparatuses, and/or methods may exclude any other features or steps beyond those disclosed herein. Elements, compositions, devices, systems, methods, and method steps not recited may be included or excluded as desired or required. Persons skilled in the art may make various changes in methods of preparing and using a composition, device, and/or system of the disclosure.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value+/−about 10%, depicted value+/−about 50%, depicted value+/−about 100%) and/or a range endpoint. With respect to the former, a value of 50 depicted in an example, table, and/or drawing may form the basis of a range of, for example, about 45 to about 55, about 25 to about 100, and/or about 0 to about 100.

All or a portion of a device and/or system for thermal spray metal coating application systems may be configured and arranged to be disposable, serviceable, interchangeable, and/or replaceable. These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

Headings (e.g., Title, Background, and Detailed Description) are provided in compliance with regulations and/or for the convenience of the reader. They do not include and should not be read to include definitive or over-arching admissions as to the scope and content of prior art or limitations applicable to all disclosed embodiments.

What is claimed is:

1. A method for coating a coiled sucker rod, the method comprising:
(a) transferring the coiled sucker rod from a first reel to a thermal spray metal gun system with a conveyance system; and
(b) applying a thermal spray metal coating on the coiled sucker rod with the thermal spray metal gun system to form a thermal spray metal coated coiled sucker rod.

2. The method for coating the coiled sucker rod according to claim 1, wherein the thermal spray metal coating comprises an aluminum, a zinc, a magnesium, and alloys thereof.

3. The method for coating the coiled sucker rod according to claim 1, wherein the conveyance system comprises a pinch roller, a reel drive, offset roller system, and a belt puller.

4. The method for coating the coiled sucker rod according to claim 1, further comprising:
transferring the coiled sucker rod from the first reel to a pre-heater with the conveyance system; and
pre-heating the coiled sucker rod with the pre-heater to a temperature ranging from about 0° C. to about 300° C. to form a pre-heated coiled sucker rod.

5. The method for coating the coiled sucker rod according to claim 1, further comprising:
transferring the coiled sucker rod from the first reel to an abrasive media blasting device with the conveyance system; and
blasting the pre-heated coiled sucker rod with an abrasive media from the abrasive media blasting device to form a pre-treated coiled sucker rod.

6. The method for coating the coiled sucker rod according to claim 5, wherein the abrasive media comprises a grit, a shot, an alumina, a silica, and a combination thereof.

7. The method for coating the coiled sucker rod according to claim 1, further comprising:
transferring the coiled sucker rod from the first reel to a pre-heater with the conveyance system;
pre-heating the coiled sucker rod with the pre-heater to a temperature ranging from about 0° C. to about 300° C. to form a pre-heated coiled sucker rod;
transferring the pre-heated coiled sucker rod from the pre-heated to an abrasive media blasting device with the conveyance system; and
blasting the pre-heated coiled sucker rod with an abrasive media in the abrasive media blasting device to form a pre-treated coiled sucker rod.

8. The method for coating the coiled sucker rod according to claim 5, further comprising:
transferring the pre-treated coiled sucker rod from the abrasive media blasting device to the thermal spray metal gun system with the conveyance system.

9. The method for coating the coiled sucker rod according to claim 1, further comprising:
drawing the thermal spray metal coated coiled sucker rod into a second reel with the conveyance system.

10. The method for coating the coiled sucker rod according to claim 1, further comprising:
transferring the thermal spray metal coated coiled sucker rod from the thermal spray metal gun system to a sealant applicator system with the conveyance system; and
applying a sealant to the thermal spray metal coated coiled sucker rod in the sealant applicator system to produce a sealed coiled sucker rod.

11. The method for coating the coiled sucker rod according to claim 10, wherein the sealant comprises one or more of an epoxy, a silicone, a phenol resin, a moisture cured urethane, a urethane, and an aliphatic urethane.

12. The method for coating the coiled sucker rod according to claim 10, wherein the sealant is applied at a thickness ranging from about 0.1 millimeters to about 5.0 millimeter.

13. The method for coating the coiled sucker rod according to claim 1, wherein the thermal spray metal coating is applied at a thickness ranging from about 0.1 millimeters to about 5.0 millimeter.

14. The method for coating the coiled sucker rod according to claim 10, further comprising:
transferring the sealed coiled sucker rod from the sealant applicator system to a post-heater with the conveyance system; and
curing the sealant on the sealed coiled sucker rod in a post-heater to form a cured sealant-coiled sucker rod.

15. The method for coating the coiled sucker rod according to claim 10, wherein the sealant applicator system comprises a waterfall sealant booth.

16. The method for coating the coiled sucker rod according to claim 14, wherein the post-heater is set at a temperature ranging from about 50° C. to about 200° C.

17. The method for coating the coiled sucker rod according to claim 14, further comprising:
drawing the cured sealant-coiled sucker rod from the post-heater into a second reel with the conveyance system.

18. A system for coating a coiled sucker rod, the system comprising:
a conveyance system configured to transport the coiled sucker rod to different components of the system;
a first reel configured to contain a coiled sucker rod;
a pre-heater connected to the first reel through the conveyance system and configured to receive the coiled sucker rod from the first reel through actuation of the conveyance system, wherein the pre-heater is further configured to heat the coiled sucker rod to a temperature ranging from about 0° C. to about 300° C., forming a pre-heated coiled sucker rod;
an abrasive media blasting device comprising an abrasive media tank, a compressor, an abrasive media spray nozzle, and an air tank, the abrasive media blasting device connected to the pre-heater through the conveyance system and configured to receive the pre-heated coiled sucker rod from the pre-heater through actuation of the conveyance system, wherein the abrasive media blasting device is further configured to blast the pre-heated coiled sucker rod with the abrasive media to form a pre-treated coiled sucker rod; and
a thermal spray metal gun system connected to the abrasive media blasting device through the conveyance system and configured to receive the pre-treated coiled sucker rod from the abrasive media blasting device through actuation of the conveyance system, wherein the thermal spray metal gun system is further configured to apply a thermal spray metal coating on the pre-treated coiled sucker rod to form a thermal spray metal coated coiled sucker rod.

19. The system for coating the coiled sucker rod according to claim 18, further comprising a computer processor electronically connected to and configured to control the conveyance system, the pre-heater, the abrasive media blasting device, and the thermal spray metal gun system.

20. The system for coating a coiled sucker rod according to claim 18, further comprising:
a degreasing system located in between the pre-heater and the abrasive media blasting device,
wherein the degreasing system is connected to each of the pre-heater and the abrasive media blasting device through the conveyance system, and
wherein the degreasing system comprises one or more of:
a heater configured to heat the pre-heated coiled sucker rod to a temperature ranging from about 0° C. to about 300° C.;
a high pressure water spray system comprising a water tank, a pump, and one or more spray nozzles;
a degreasing applicator system comprising a solvent drum, a pump, and one or more spray nozzles; and
an air dryer.

21. The system for coating the coiled sucker rod according to claim 18, further comprising:
a sealant applicator system that is connected to the thermal spray metal gun system through the conveyance system,
wherein the sealant applicator system is configured to receive the thermal spray metal coated coiled sucker rod from the thermal spray metal gun system through actuation of the conveyance system, wherein the sealant applicator system is further configured to apply a sealant to the thermal spray metal coated coiled sucker rod to produce a sealed coiled sucker rod.

22. The system for coating the coiled sucker rod according to claim 21, wherein the sealant applicator system comprises a waterfall sealant booth.

23. The system for coating the coiled sucker rod according to claim 21, further comprising:
a post-heater comprising one or more heaters and is connected to the sealant applicator system through the conveyance system,
wherein the post-heater is configured to receive the sealed coiled sucker rod from the sealant applicator system through actuation of the conveyance system, and
wherein the post-heater is configured to heat the sealed coiled sucker rod to a temperature ranging from about 50° C. to about 200° C. to form a cured sealant-coiled sucker rod.

24. The system for coating the coiled sucker rod according to claim 23, further comprising:
a second reel configured to receive the cured sealant-coiled sucker rod from the post-heater through actuation of the conveyance system.

25. The system for coating the coiled sucker rod according to claim 18, wherein the conveyance system comprises a pinch roller, a reel drive, offset roller system, and a belt puller.
